(19) United States
(12) Patent Application Publication
(10) Pub. No.: US 2014/0134460 A1
(43) Pub. Date: May 15, 2014

(54) ENERGY STORAGE SYSTEM

(71) Applicant: SAMSUNG SDI CO., LTD., Yongin-si (KR)

(72) Inventor: Garam YOUN, Yongin-si (KR)

(73) Assignee: SAMSUNG SDI CO., LTD., Yongin-si (KR)

(21) Appl. No.: 13/895,390

(22) Filed: May 16, 2013

Related U.S. Application Data
(60) Provisional application No. 61/725,646, filed on Nov. 13, 2012.

(51) Int. Cl. H01M 2/10

(52) U.S. Cl. CPC H01M 2/1022
USPC 429/7; 211/26; 429/99

(57) ABSTRACT

A rack and an energy storage system, the rack including guide plates for co-operation with battery trays to be arranged in the rack; tray supporting units for holding the battery trays, the tray supporting units being coupled with the guide plates; and tray fixing units on the guide plates, the tray fixing units fixing the tray supporting units in place and substantially constraining the tray supporting units against displacement.

### CROSS-REFERENCE TO RELATED APPLICATION

The present application claims priority under 35 U.S.C. §119 to U.S. Provisional Application No. 61/725,646, filed on Nov. 13, 2012, and entitled: “Energy Storage System,” which is incorporated herein by reference in its entirety.

### BACKGROUND

1. Field

Embodiments relate to a rack and an energy storage system.

2. Description of the Related Art

An energy storage system may be used in association with a renewable energy and power system, e.g., a solar cell. The energy storage system may be configured to store power when power demanded from a load is small, and then use the stored power when the demand for power is increased. The energy storage system may include a large quantity of secondary batteries, which may also be used in electronic devices, such as cellular phones, or notebook computers.

### SUMMARY

Embodiments are directed to a rack and an energy storage system.

The embodiments may be realized by providing a rack including guide plates for co-operation with battery trays to be arranged in the rack; tray supporting units for holding the battery trays, the tray supporting units being coupled with the guide plates; and tray fixing units on the guide plates, the tray fixing units fixing the tray supporting units in place and substantially constraining the tray supporting units against displacement.

The rack may further including a top frame; a bottom frame parallel with the top frame; side frames extending perpendicularly with respect to the top frame and the bottom frame and connecting the top frame and the bottom frame; shelf frames extending in parallel with the top frame and the bottom frame on a front and a back of the rack and being coupled with the side frames.

The guide plates may each include a first region extending in parallel with the top frame and bottom frame, and a second region extending perpendicularly from the first region, the second region being coupled with the side frames, and the tray fixing units may be on an inner surface of the second region.

The tray supporting units may each include a first plate, a bottom surface of the first plate being supported by the first region of the guide plate, and a second plate extending perpendicularly from the first plate along a front of the rack.

The tray supporting units may be inserted into the front of the rack.

The tray fixing unit may be coupled with a top surface of the first plate of the tray supporting unit.

The tray fixing unit may include a coupling region coupled with the inner surface of the second region of the guide plate, and a fixing region contacting a top surface of the first plate of the tray supporting unit such that a portion of the tray supporting unit is between the fixing region of the tray fixing unit and the first region of the guide plate.

The fixing region of each tray fixing unit may include a pair of first fixing regions extending away from the coupling region, and a second fixing region at ends of the first fixing regions, the second fixing region being spaced apart from the second region of the guide plate and extending in parallel with the coupling region, and bottom surfaces of the first fixing region and the second fixing region may contact the top surface of the first plate of the tray supporting unit.

The pair of first fixing regions may extend away from the coupling region by a distance of about 10 mm or greater.

A length of the bottom surface of the second fixing region that contacts the top surface of the first plate of the tray supporting unit may be about 60 mm or greater.

The fixing region of each of the tray fixing units may extend perpendicularly from the coupling region and may include a pair of first fixing regions extending in parallel with the top frame and the bottom frame, a second fixing region spaced apart from and extending in parallel with the pair of first fixing regions, a bottom surface of the second fixing region contacting the top surface of the first plate of the tray supporting unit, and a pair of connecting fixing regions connecting an end of each of the first fixing regions and an end of the second fixing region

The connecting fixing regions may be inclined with respect to planes of the first fixing regions and the second fixing region.

The fixing region may extend perpendicularly from the coupling region by a distance of about 10 mm or greater.

A length of the bottom surface of the second fixing region that contacts the top surface of the first plate of the tray supporting unit may be about 50 mm or greater.

The embodiments may also be realized by providing an energy storage system including a rack for arranging battery trays in a vertical stack, the rack including guide plates for co-operation with the battery trays to be arranged in the rack; tray supporting units for holding the battery trays, the tray supporting units being coupled with the guide plates; and tray fixing units on the guide plates, the tray fixing units vertically fixing the tray supporting units in place and substantially constraining the tray supporting units against vertical displacement.

The guide plates may each include a first region extending perpendicularly with respect to the vertical stack, and a second region extending perpendicularly from the first region, the tray fixing units may be on an inner surface of the second region, and the tray supporting units may each include a first plate, a bottom surface of the first plate being supported by the first region of the guide plate, and a second plate extending perpendicularly from the first plate along a front of the rack.

Each of the tray fixing units may include a coupling region coupled with the inner surface of the second region of the guide plate, and a fixing region contacting a top surface of the first plate of the tray supporting unit such that a portion of the tray supporting unit is between the fixing region of the tray fixing unit and the first region of the guide plate.

The energy storage system may further include the battery trays, the battery trays being supported by the tray supporting unit, and each including at least one battery cell.

The energy storage system may further include connector units on a back of the rack, a number of connector units corresponding with a number of battery trays, the connector units being connected to the battery cells in the battery trays.

The energy storage system may further include at least one of a battery management box and a switch box, the battery management box being connected to the connector units and managing charging and discharging of the battery cells in the battery trays; and the switch box being connected to the connector units and including a protection circuit device for protecting the battery cells in the battery trays.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of an energy storage system according to an embodiment;

FIG. 2 illustrates an exploded perspective view of a battery tray of the energy storage system according to an embodiment;

FIG. 3 illustrates a perspective view of a tray supporting unit of the energy storage system according to an embodiment;

FIG. 4 illustrates a perspective view of a rack of the energy storage system according to an embodiment;

FIG. 5 illustrates an enlarged view of a portion of the rack of FIG. 4, in which the tray fixing unit is included in the rack of the energy storage system according to an embodiment;

FIG. 6 illustrates a state in which the tray supporting unit is coupled with the tray fixing unit shown in FIG. 5;

FIG. 7 illustrates a cross-sectional view taken along line A-A′ of FIG. 4;

FIG. 8 illustrates a perspective view of a tray fixing unit of the energy storage system according to an embodiment;

FIG. 9 illustrates a rear view of a state in which battery trays in the rack are connected in the energy storage system according to an embodiment;

FIG. 10 illustrates an enlarged view of a portion of a rack in which the tray fixing unit is included in the rack of the energy storage system according to another embodiment;

FIG. 11 illustrates a cross-sectional view of a rack in which the tray fixing unit is included in the rack of the energy storage system according to another embodiment; and

FIG. 12 illustrates an enlarged view of the tray fixing unit in the energy storage system according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

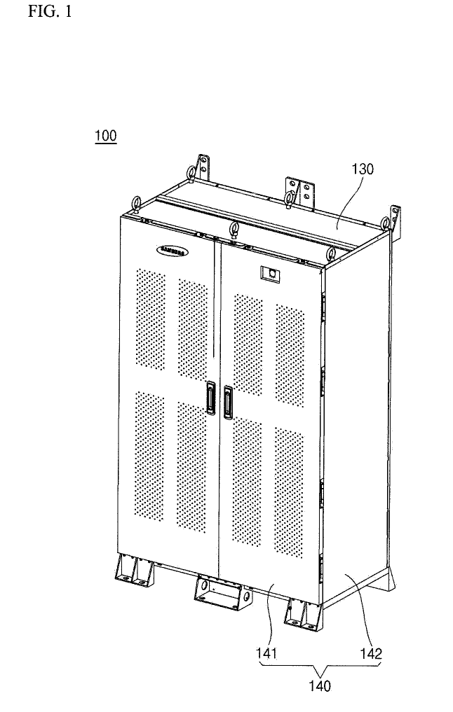

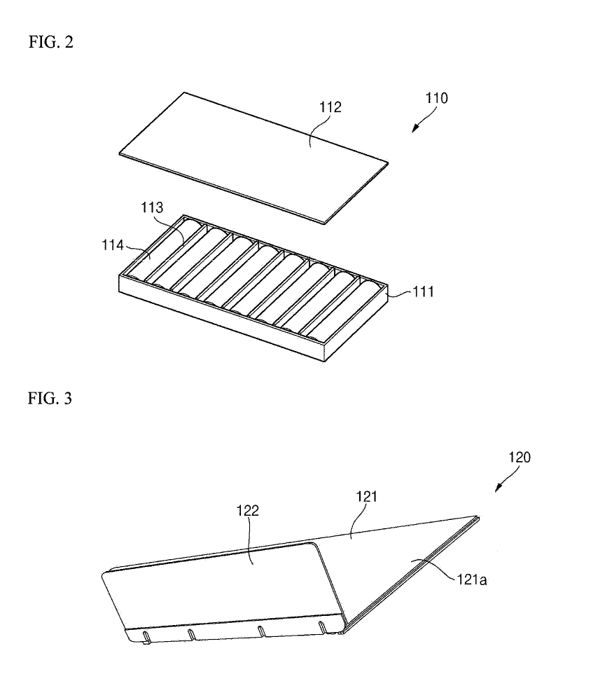

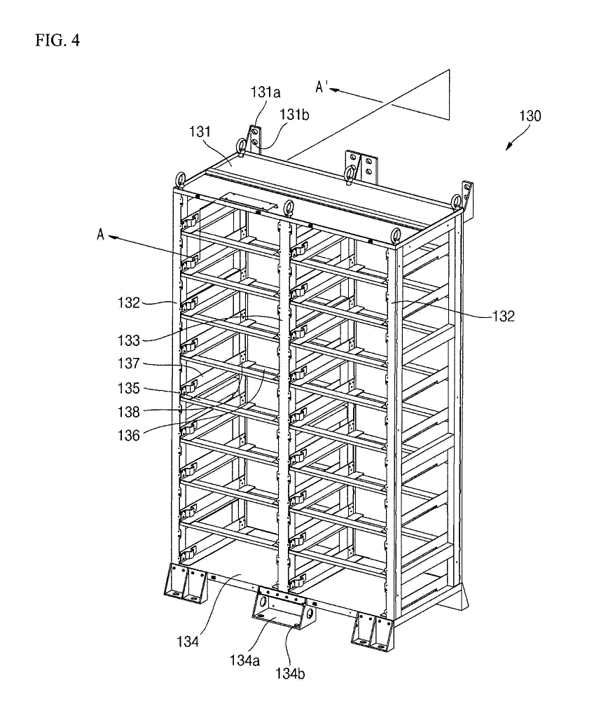

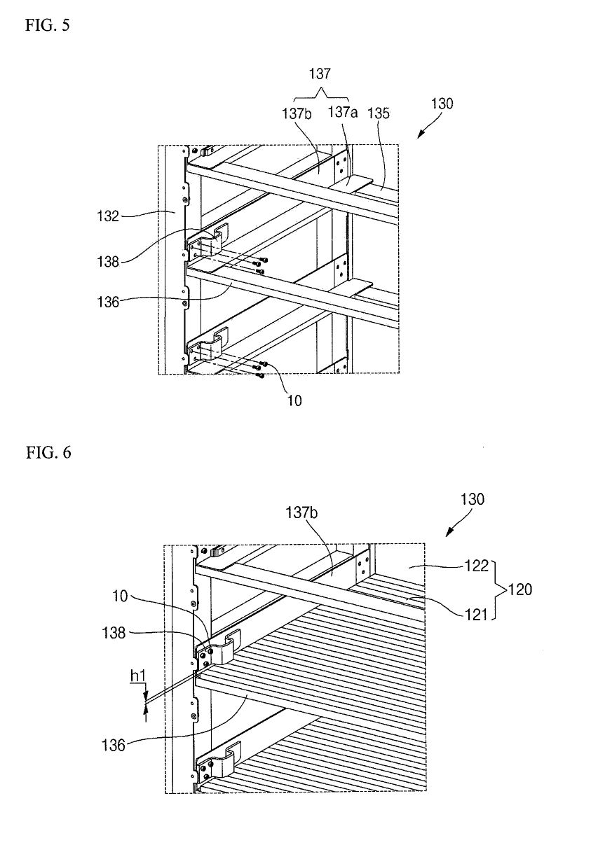

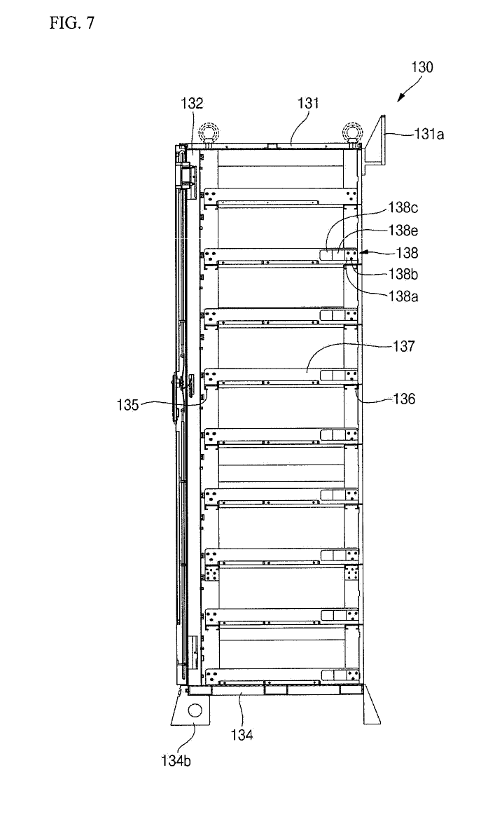

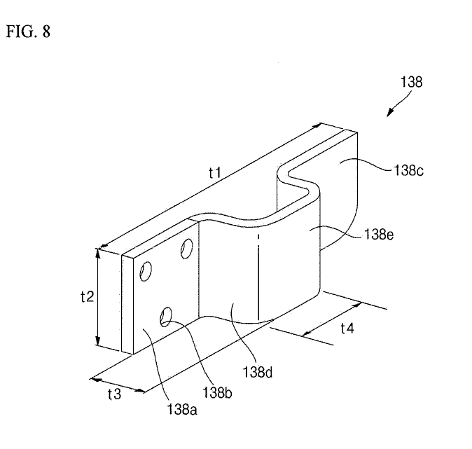

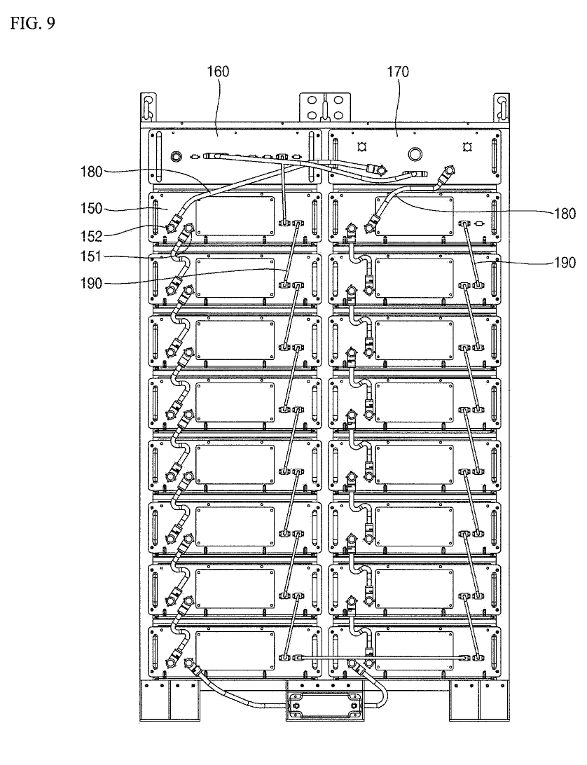

FIG. 1 illustrates a perspective view of an energy storage system according to an embodiment, FIG. 2 illustrates an exploded perspective view of a battery tray of the energy storage system according to an embodiment, FIG. 3 illustrates a perspective view of a tray supporting unit of the energy storage system according to an embodiment, FIG. 4 illustrates a perspective view of a rack of the energy storage system according to an embodiment, FIG. 5 illustrates an enlarged view of a portion of the rack in which the tray fixing unit is included in the rack of the energy storage system according to an embodiment, FIG. 6 illustrates a state in which the tray supporting unit is coupled with the tray fixing unit shown in FIG. 5, FIG. 7 illustrates a cross-sectional view taken along the line A-A′ of FIG. 4, FIG. 8 illustrates a perspective view of a tray fixing unit of the energy storage system according to an embodiment, and FIG. 9 illustrates a rear view illustrating a state in which battery trays in the rack are connected in the energy storage system according to an embodiment.

The energy storage system 100 may include battery trays 110, a tray supporting unit 120, a rack 130, connector units 150, a battery management box 160, a switch box 170, power supply wires 180, and communication wires 190. In an implementation, the energy storage system 100 may further include covers 140 coupled to front and side surfaces of the rack 130.

The battery trays 110 may be accommodated in the rack 130. The battery trays 110 may each include a first case 111 and a second case 112. The first case 111 may be box-shaped and may have an accommodation space inside. The first case may include a plurality of partitions 113 in an internal space to separately accommodate a plurality of battery cells 114. The second case 112 may be plate-shaped and may be coupled to the first case 111 accommodating the plurality of battery cells 114. In an implementation, the first case 111 and the second case 112 may be made of an insulating material, e.g., a plastic material. A number of the battery trays 110 may be adjusted according to a size of the rack 130. In an implementation, although not shown, each of the battery trays 110 may further include a battery management system (BMS) embedded therein to control charging and discharging of the battery cells 114.

The tray supporting unit 120 may include a plurality of tray supporting units 120, which may be inserted into the rack 130 to be coupled thereto. For example, the tray supporting units 120 may be inserted into a front side of the rack 103. In addition, the tray supporting unit 120 may support bottom portions of the battery trays 110 to facilitate safe mounting of the battery trays 110 in the rack 130. Positions of the tray supporting units 120 may be fixed within the rack 130, thereby allowing the battery trays 110 positioned thereon to be safety placed in the rack 130.

The tray supporting unit 120 may include a first plate 121 (formed or extending in one direction) to be inserted into the rack 130, and a second plate 122 (formed to be perpendicular to the first plate 121). The first plate 121 may be inserted into the rack 130, and a position of a side portion 121a of the first plate 121 may be fixed within the rack 130, thereby reducing the likelihood of and/or preventing the battery trays 110 from vibrating in the rack 130, even in the event of an external vibration being applied to the rack 130.

The rack 130 may include a top frame 131, a pair of side frames 132 (downwardly extending from the top frame 131 to be perpendicular to the top frame 131), and a bottom frame 134 at a bottom portion of the rack 130 to be connected to the side frames 132. In an implementation, the rack 130 may include a middle frame 133 installed between the side frames 132 to be parallel to the side frames 132. In addition, the rack 130 may include a plurality of first shelf frames 135 on a front surface between the top frame 131 and the bottom frame 134 to be parallel to the top frame 131 and the bottom frame 134, and a plurality of second shelf frames 136 on a rear surface between the top frame 131 and the bottom frame 134.

In addition, a guide plate 137 may be formed widthwise on each of the side frames 132 (and, if present, the middle frame 133) to connect the first shelf frames 135 and the second shelf frames 136. The guide plate 137 may have a length corresponding to a distance between each of the first shelf frames 135 and corresponding ones of the second shelf frames 136, e.g., a thickness of the rack 130.

The guide plate 137 may include a first region 137a (extending from the first shelf frame 135 to the second shelf frame 136 on top surfaces of the first shelf frame 135 and the second shelf frame 136), and a second region 137b (vertically bent from the first region 137a). The first region 137a may support the tray supporting unit 120 from a bottom and may be fastened or coupled to the tray supporting unit 120. The tray supporting unit 120 may move along the first region 137a when inserted into the rack 130, e.g., at the front side of the rack 130. In addition, the second region 137b may be a region to which the following components for fixing the tray supporting unit 120 may be coupled.

The rack 130 may include a tray fixing unit 138 formed on an interior side of the second region 137b of the guide plate 137. The tray fixing unit 138 may protrude on or over a top portion or surface of the tray supporting unit 120 and may support the top portion of the tray supporting unit 120. Therefore, the tray fixing unit 138 may help control and/or suppress vertical vibration of the tray supporting unit 120, thereby controlling and/or suppressing vibration of the battery trays 110.

For example, the tray fixing unit 138 may include a coupling region 138a, 138c coupled with the second region 137b of the guide plate 137 at an end of the second region 137b of the guide plate 137. In an implementation, a portion of the coupling region 138a may include at least one hole 138b formed therein to be coupled with the guide plate 137 by external coupler (e.g., bolts, 10).

In addition, another portion of the coupling region 138c may be coupled with the second region 137b of the guide plate 137 at another end symmetrical to the first region 138a. In an implementation, the other portion of the coupling region 138c may be maintained at a state in which it is coupled with the guide plate 137 by, e.g., welding.

The tray fixing unit 138 may include a fixing region 138d, 138e contacting a top surface of the first plate 121 of the tray supporting unit 120 such that a portion of the tray supporting unit 120 is between the fixing region 138d, 138e of the tray fixing unit 138 and the first region 137a of the guide plate 137. The fixing region 138d, 138e may include a pair of first fixing regions 138d protruding or extending away from the coupling region 138a, 138c. The fixing region 138d, 138e may include a second fixing region 138e between the first fixing regions 138d. For example, the second fixing region 138e may be at ends of the first fixing regions 138d and may be spaced apart from the second region 137b of the guide plate 137. The second fixing region 138e may extend in parallel with the coupling region 138a, 138c. For example, the second fixing region 138e may protrude on or over the top portion of the tray supporting unit 120. Thus, vertical vibration of the tray supporting unit 120 may be suppressed. Therefore, it is possible to help reduce the likelihood and/or prevent the tray supporting unit 120 and the battery trays 110 from vibrating, thereby increasing stability of the energy storage system 100.

In an implementation, a length t1 of the tray fixing unit 138 may be about 110 mm or greater. Maintaining the length t1 of the tray fixing unit 138 at about 110 mm or greater may help ensure that the tray fixing unit 138 is coupled to the second region 137b of the guide plate 137, and may provide for a length long enough to fix the tray supporting unit 120.

In an implementation, a width t2 of the tray fixing unit 138 may be about 30 mm or greater. Maintaining the width t2 of the tray fixing unit 138 at about 30 mm or greater may help secure a sufficient coupling strength between the coupling region 138a, 138c of the tray fixing unit 138 and the guide plate 137.

In an implementation, a height t3 of the first fixing regions 138d protruding from the coupling region 138a, 138c may be about 10 mm or greater. Maintaining the height t3 of the first fixing regions 138d at about 10 mm or greater may help ensure that the tray fixing unit 138 is able to reduce the likelihood and/or prevent edges of the side portion 121a of the tray supporting unit 120 from deforming while stably supporting the tray supporting unit 120.

In an implementation, a length t4 of the second fixing region 138e of the tray fixing unit 138 may be about 60 mm or greater. Maintaining the length t4 of the second fixing region 138e of the tray fixing unit 138 at about 60 mm or greater may help ensure that the second fixing region 138e is able to reduce the likelihood of and/or prevent edges of the side portion 121a of the tray supporting unit 120 from deforming while stably supporting the tray supporting unit 120.

In an implementation, a distance hl between the tray fixing unit 138 and the tray supporting unit 120 may be about 0.5 mm or less. Maintaining the distance hl between the tray fixing unit 138 and the tray supporting unit 120 at about 0.5 mm or less may help ensure that the tray supporting unit 120 vertically tightly contacts with the tray fixing unit 138 to, thereby reducing and/or preventing vertical vibration, and may help reduce and/or prevent deformation of the side portion 121a of the tray supporting unit 120 due to external vibration.

The cover 140 may include a front cover 141 on a front surface of the rack 130 and a side cover 142 on a side surface of the rack 130. The front cover 141 may include hinges at edges thereof to be opened by a user when desired. In addition, the side cover 142 may be coupled with side frames 132 of the rack 130 to protect the trays 110 provided inside.

The connector units 150 may be on a rear surface of the rack 130 opposite to the front cover 141. A number of the connector units 150 may be equal to that of the battery trays 110, and the connector units 150 may be coupled with the battery trays 110, respectively, to be electrically connected to the battery cells 114 in the battery trays 110. The connector units 150 may provide paths for charging and discharging operations and communication for the battery cells 114.

The battery management box 160 may have a same size as the battery tray 110 to be accommodated in the rack 130. The battery management box 160 may include circuit devices for controlling communications with respective battery trays 110. The battery management box 170 may identify states of the battery cells 114 accommodated in the battery trays 110 through the circuit devices.

The switch box 170 may have the same size as the battery tray 110 to be accommodated in the rack 130. The switch box 170 may include a protection circuit device for protecting the battery cells 114. For example, the protection circuit device may be a fuse or switching device that disconnects a flow of current when current supplied to the battery cells 114 is greater than a current limit of the battery cells 114.

The power supply wires 180 may connect the connector units 150 and the switch box 170. Thus, the power supply wires 180 may establish electrical connections between the battery trays 110 coupled with the connector units 150 while providing charging and discharging paths.

The communication wires 190 may connect the connector units 150, the battery management box 160, and the switch box 170 to one another. The communication wires 190 may provide communication paths to allow the battery management box 160 to monitor states of the battery cells 114 provided in the battery trays 110.

Hereinafter, a configuration of an energy storage system according to another embodiment will be described.

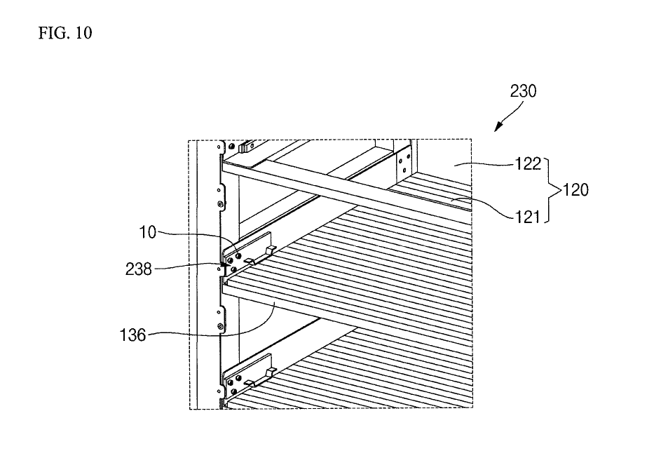

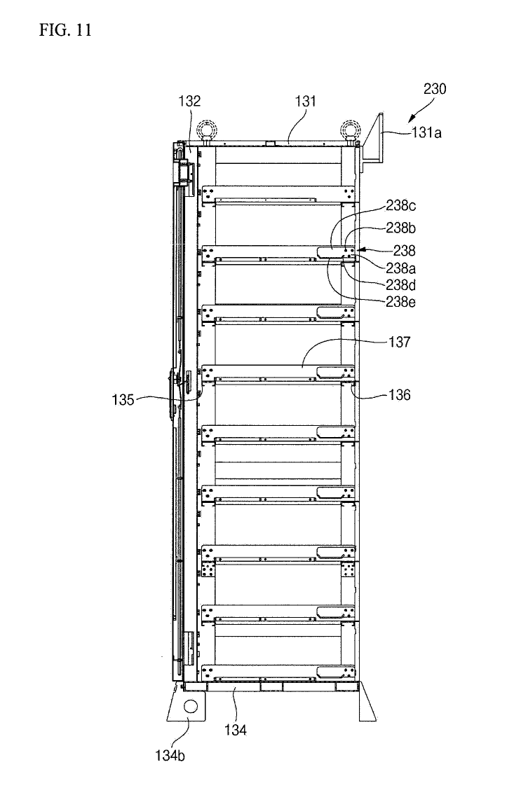

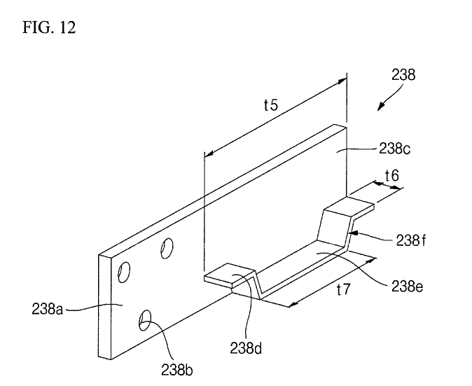

FIG. 10 illustrates an enlarged view of a portion of a rack in which a tray fixing unit is foamed in the rack of an energy storage system according to another embodiment, FIG. 11 illustrates a cross-sectional view of a portion where the tray fixing unit is formed in the rack of the energy storage system according to another embodiment, and FIG. 12 illustrates an enlarged view of the tray fixing unit in the energy storage system according to another embodiment.

The same functional components as those of the previous embodiment are denoted by the same reference numerals, and the following description will focus on differences between the previous and present embodiments.

Referring to FIGS. 10 to 12, the energy storage system according to the present embodiment may include a rack 230 coupled with tray supporting units 120. For example, the tray supporting units 120 may be inserted into a front side of the rack 230.

The rack 230 may include tray fixing units 238 coupled with guide plates 137. Each of the tray fixing units 238 may include a coupling region 238a, 238c coupled with a second region 137b of each of the guide plates 137 at one end of the second region 137b of the guide plate 137. The coupling region 238a, 238c may include at least one hole 238b. In such a manner, the tray fixing units 238 may be coupled to the guide plates 137 through external couplers, e.g., bolts.

The coupling region 238a, 238c of the tray fixing unit 238 may include another coupling region 238c coupled with the guide plate 137 at another end symmetrical to the one coupling region 238a. The other coupling region 238c may be coupled with the guide plates 137 by, e.g., welding.

In an implementation, the tray fixing unit 238 may include a pair of first fixing regions 238d protruding from the coupling region 238a, 238c, and a second fixing region 238e between the pair of first fixing regions 238d to be tilted or offset with respect to the first fixing regions 238d. The second fixing region 238e may extend in a lengthwise direction of the tray fixing unit 238 and may fix a side portion 121a of the tray supporting unit 120, thereby fixing the tray supporting unit 120 and battery trays. In an implementation, a pair of connecting fixing regions 238f may connect an end of each of the first fixing regions 238d and an end of the second fixing region 238e. In an implementation, the connecting fixing regions 2338f may be inclined with respect to planes of the first fixing regions 238d and the second fixing regions 238e.

In an implementation, a length t5 of both of the first fixing regions 238d together with the second fixing region 238e may be about 60 mm or greater. Maintaining the length t5 of both of the first fixing regions 238d together with the second fixing region 238e at about 60 mm or greater may help ensure that the second fixing region 238e is able to reduce the likelihood of and/or prevent edges of the side portion 121a of the tray supporting unit 120 from deforming while stably supporting the tray supporting unit 120.

In an implementation, a protrusion distance t6 of each of the first fixing regions 238d and the second fixing region 238e, e.g., protruding from the coupling region 238a, 238c of the tray fixing unit 238 may be about 10 mm or greater. Maintaining the height t6 of each of the first fixing regions 238d and the second fixing region 238e at about 10 mm or greater may help ensure that the tray fixing unit 238 is able to help reduce the likelihood of and/or prevent deformation of edges of the side portion 121a of the tray supporting unit 120 while stably supporting the tray supporting unit 120.

In an implementation, a length t7 of the second fixing region 238e of the tray fixing unit 238 may be about 50 mm or greater. Therefore, the second fixing region 238e may make a sufficiently long, or longer than necessary, contact area with the tray supporting unit 120, thereby stably supporting the side portion 121a of the tray supporting unit 120.

By way of summation and review, a large quantity of secondary batteries may be accommodated in multiple trays, which may be accommodated in a rack. The rack accommodating the trays should secure stability against a vibration, e.g., earthquake or external shock.

The embodiments provide a rack, e.g., for an energy storage system, which may help suppress vibration of trays in the rack.

As described above, the energy storage system according to an embodiment may include at least one tray fixing unit inwardly protruding with respect to the guide plate formed between the side frames, the tray supporting unit inserted into the inside of the side frames from a front of the rack and along the guide plate may be vertically fixed, thereby easily preventing the tray supporting unit and the trays from vibrating in the rack.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A rack, comprising:
guide plates for co-operation with battery trays to be arranged in the rack;
tray supporting units for holding the battery trays, the tray supporting units being coupled with the guide plates; and
tray fixing units on the guide plates, the tray fixing units fixing the tray supporting units in place and substantially constraining the tray supporting units against displacement.

2. The rack as claimed in claim 1, further comprising:
a top frame;
a bottom frame parallel with the top frame;
side frames extending perpendicularly with respect to the top frame and the bottom frame and connecting the top frame and the bottom frame;
shelf frames extending in parallel with the top frame and the bottom frame on a front and a back of the rack and being coupled with the side frames.

3. The rack as claimed in claim 2, wherein:
the guide plates each include:
a first region extending in parallel with the top frame and bottom frame, and
a second region extending perpendicularly from the first region, the second region being coupled with the side frames, and
the tray fixing units are on an inner surface of the second region.

4. The rack as claimed in claim 3, wherein the tray supporting units each include:
a first plate, a bottom surface of the first plate being supported by the first region of the guide plate, and
a second plate extending perpendicularly from the first plate along a front of the rack.

5. The rack as claimed in claim 4, wherein the tray supporting units are inserted into the front of the rack.

6. The rack as claimed in claim 4, wherein the tray fixing unit is coupled with a top surface of the first plate of the tray supporting unit.

7. The rack as claimed in claim 4, wherein the tray fixing unit includes:
a coupling region coupled with the inner surface of the second region of the guide plate, and
a fixing region contacting a top surface of the first plate of the tray supporting unit such that a portion of the tray supporting unit is between the fixing region of the tray fixing unit and the first region of the guide plate.

8. The rack as claimed in claim 7, wherein:
the fixing region of each tray fixing unit includes:
a pair of first fixing regions extending away from the coupling region, and
a second fixing region at ends of the first fixing regions, the second fixing region being spaced apart from the second region of the guide plate and extending in parallel with the coupling region, and
bottom surfaces of the first fixing region and the second fixing region contact the top surface of the first plate of the tray supporting unit.

9. The rack as claimed in claim 8, wherein the pair of first fixing regions extend away from the coupling region by a distance of about 10 mm or greater.

10. The rack as claimed in claim 8, wherein a length of the bottom surface of the second fixing region that contacts the top surface of the first plate of the tray supporting unit is about 60 mm or greater.

11. The rack as claimed in claim 7, wherein the fixing region of each of the tray fixing units extends perpendicularly from the coupling region and includes:
a pair of first fixing regions extending in parallel with the top frame and the bottom frame,
a second fixing region spaced apart from and extending in parallel with the pair of first fixing regions, a bottom surface of the second fixing region contacting the top surface of the first plate of the tray supporting unit, and
a pair of connecting fixing regions connecting an end of each of the first fixing regions and an end of the second fixing region

12. The rack as claimed in claim 11, wherein the connecting fixing regions are inclined with respect to planes of the first fixing regions and the second fixing region.

13. The rack as claimed in claim 11, wherein the fixing region extends perpendicularly from the coupling region by a distance of about 10 mm or greater.

14. The rack as claimed in claim 11, wherein a length of the bottom surface of the second fixing region that contacts the top surface of the first plate of the tray supporting unit is about 50 mm or greater.

15. An energy storage system comprising a rack for arranging battery trays in a vertical stack, the rack including:
guide plates for co-operation with the battery trays to be arranged in the rack;
tray supporting units for holding the battery trays, the tray supporting units being coupled with the guide plates; and
tray fixing units on the guide plates, the tray fixing units vertically fixing the tray supporting units in place and substantially constraining the tray supporting units against vertical displacement.

16. The energy storage system as claimed in claim 15, wherein:
the guide plates each include:
a first region extending perpendicularly with respect to the vertical stack, and
a second region extending perpendicularly from the first region, the tray fixing units are on an inner surface of the second region, and the tray supporting units each include:
a first plate, a bottom surface of the first plate being supported by the first region of the guide plate, and
a second plate extending perpendicularly from the first plate along a front of the rack.

17. The energy storage system as claimed in claim 16, wherein each of the tray fixing units includes:
a coupling region coupled with the inner surface of the second region of the guide plate, and
a fixing region contacting a top surface of the first plate of the tray supporting unit such that a portion of the tray supporting unit is between the fixing region of the tray fixing unit and the first region of the guide plate.

18. The energy storage system as claimed in claim 15, further comprising the battery trays, the battery trays:
being supported by the tray supporting unit, and
each including at least one battery cell.

19. The energy storage system as claimed in claim 18, further comprising connector units on a back of the rack, a number of connector units corresponding with a number of battery trays, the connector units being connected to the battery cells in the battery trays.

20. The energy storage system as claimed in claim 19, further comprising at least one of a battery management box and a switch box,
the battery management box being connected to the connector units and managing charging and discharging of the battery cells in the battery trays; and
the switch box being connected to the connector units and including a protection circuit device for protecting the battery cells in the battery trays.
